(19) United States
(12) Patent Application Publication
(10) Pub. No.: US 2026/0366658 A1
(43) Pub. Date: Nov. 19, 2026

(54) Quick-Release Clamp and Band Cutter System

(71) Applicants: Michael Allen Woodley, METAMORA, MI (US); Quinn Thomas Poor, METAMORA, MI (US)

(72) Inventors: Michael Allen Woodley, METAMORA, MI (US); Quinn Thomas Poor, METAMORA, MI (US)

(21) Appl. No.: 19/674,269

(22) Filed: May 12, 2026

Related U.S. Application Data
(60) Provisional application No. 63/805,232, filed on May 13, 2025.

(51) Int. Cl. F16L 33/08

(52) U.S. Cl. CPC F16L 33/08

(57) ABSTRACT

The present invention provides a modular quick-release hose clamp system combined with a precision band cutter, enabling users to create custom-length clamps on demand with safe, clean band edges. The system addresses the limitations of traditional fixed-size clamps by offering a customizable solution that is easy to assemble, adjust, install, and remove, while also reducing safety hazards associated with conventional band cutting and clamp installation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable.

### STATEMENT REGARDING PRIOR DISCLOSURES BY THE INVENTOR OR A JOINT INVENTOR

Not Applicable.

### BACKGROUND OF THE INVENTION

Traditional worm drive hose clamps are widely used in automotive, industrial, and household applications for a multitude of uses. These clamps typically consist of a slotted band and a screw housing with a worm gear mechanism. When the screw is turned, it engages with the slots in the band, tightening the band around the hose or other object being clamped. One major drawback of conventional clamps, however, is their fixed sizing. They are sold in predefined diameters, forcing users to purchase and stock multiple sizes to accommodate different uses.

In many situations, users are forced to install an oversized clamp and trim off the excess banding. Cutting the band with typical tools like metal snips often leaves sharp, jagged or burred edges, which can cause injury or catch on nearby objects. If users do not cut off excess banding, it can still present a problem where the band can catch on objects and cause damage.

Some variable-size clamp kits exist, but they can be cumbersome to assemble, unintuitive for casual users, and still leave behind unsafe edges after cutting the band to size.

Quick-release hose clamps attempt to improve usability by allowing fast removal and installation without fully unscrewing the clamp. These designs often feature a pivoting or hinged screw housing that can be disengaged to open the clamp quickly. While convenient for removal and use, quick-release clamps still suffer from fixed length constraints, as well as a potential for dangerous cut edges.

There remains a need for a hose clamp system that combines the adaptability of a custom length band with the ease of use and reliability of a quick-release system, while also addressing the safety and finish of the cut end of the clamp band.

### PRIOR ART PATENTS

U.S. Pat. Nos. 4,473,928A; 3,769,665A; 7,765,650B2; 2,847,742A; 3,528,142A; 3,981,053A; 3,950,830A; 2,767,455A; 3,028,650A; 3,116,529A; 3,175,271A; 2,345,832A; 2,268,211A; 3,924,308A; 4,286,361A.

### BRIEF SUMMARY OF THE INVENTION

The present invention provides a modular quick-release hose clamp system combined with a precision band cutter, enabling users to create custom-length clamps on demand with safe, clean band edges. The system addresses the limitations of traditional fixed-size clamps by offering a customizable solution that is easy to assemble, adjust, install, and remove, while also reducing safety hazards associated with conventional band cutting and clamp installation.

The clamp kit allows the user to cut a custom length of banding to match the application, then affix the band to a clamp housing. This assembly can then be installed by wrapping the band around the object to be clamped, inserting the tail end of the band through the housing, and turning the screw until appropriately tight.

The band cutter is designed to create smooth, burr-free cuts with controlled edge geometry, such as rounded or radiused corners, thereby reducing the likelihood of cuts, abrasions, or snagging on surrounding components. The user inserts the band in the cutter to the required length, then turns the handle until the band is cut. The user then takes the cut banding and inserts one end into the housing such that the locking feature is engaged. The user can then wrap the clamp around the item to be clamped and feed the other end of the band through the other end of the housing such that it engages with the screw. The user can also pivot the screw up and away from the band, increasing the clearance and allowing the band to slide in faster. Once the band is engaged with the screw, the screw can be rotated and thus tighten the clamp until it is sufficiently installed.

On an already installed clamp that has a longer band than is desired, the cutting tool may also be used to shorten the band without uninstalling the clamp.

### BRIEF DESCRIPTION OF THE SEVERAL VIEWS OF THE DRAWINGS

FIG. 1 is a perspective view of the clamp assembly

FIG. 2 is an exploded view of the clamp assembly

FIG. 3 is a side view of the clamp assembly showing the screw pivoting feature with the screw pivoted upwards

FIG. 4 is a section view of the side profile of the clamp as in FIG. 3

FIG. 5 is a section view of the side profile of the clamp with the screw fully seated as in an installed position

FIG. 6 is a perspective view of the band cutting assembly for use in cutting the band in two locations (double band cutter), with the optional scrap catcher shown as being installed

FIG. 7 is the same view as FIG. 6 with the scrap catcher removed to show the internal mechanisms

FIG. 8 is an exploded view of the double band cutter assembly

FIG. 9 is a front view of the double band cutter assembly with the scrap catcher removed

FIG. 10 is a section view of FIG. 9

FIG. 11 is a bottom view of the double band cutter assembly

FIG. 12 is a section view of the side of the double band cutter assembly

FIG. 13 is a perspective view of the band cutting assembly for use in cutting the band in one location (single band cutter)

FIG. 14 is an exploded view of the single band cutter assembly

FIG. 15 is a front view of the single band cutter assembly

FIG. 16 is a section view of FIG. 15

FIG. 17 is a section view of the side of the single band cutter assembly

FIG. 18 is a bottom view of the single cutter assembly

FIG. 19 is a view of the ends of sections of banding cut with the band cutter (the top band) such that the sharp corners are removed, compared to a band cut with some type of common metal shear (the bottom band) which presents dangerously sharp corners and edges

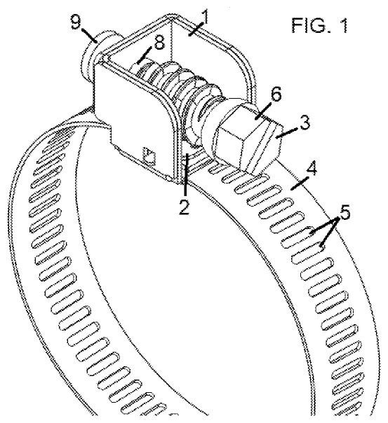

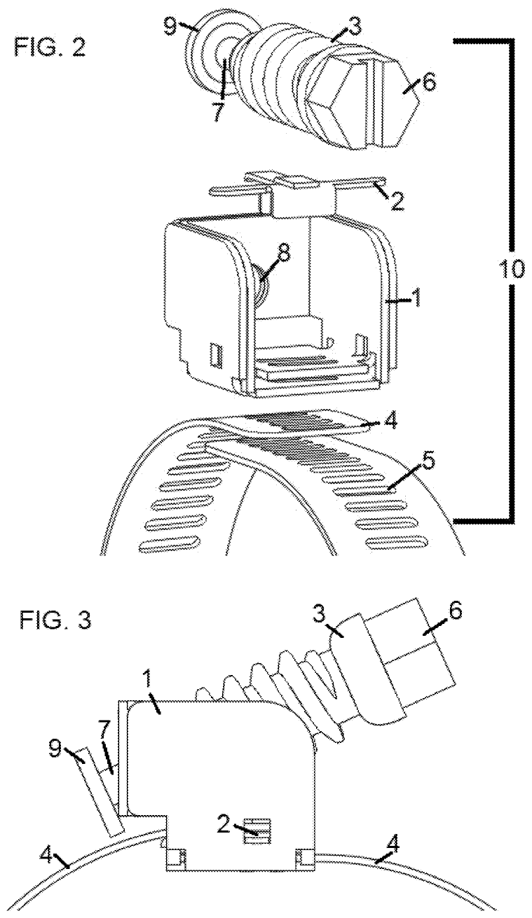

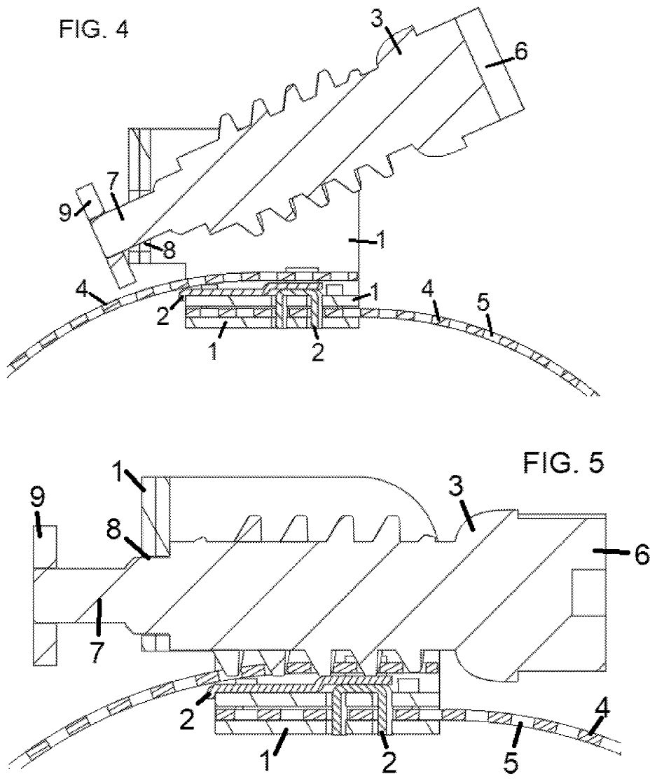

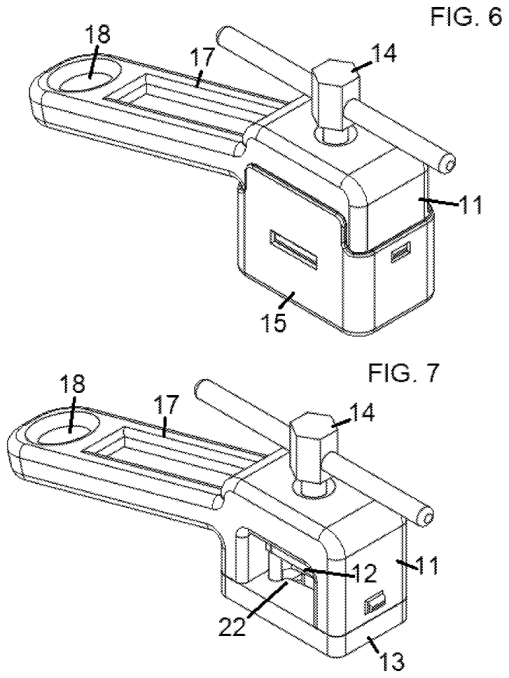

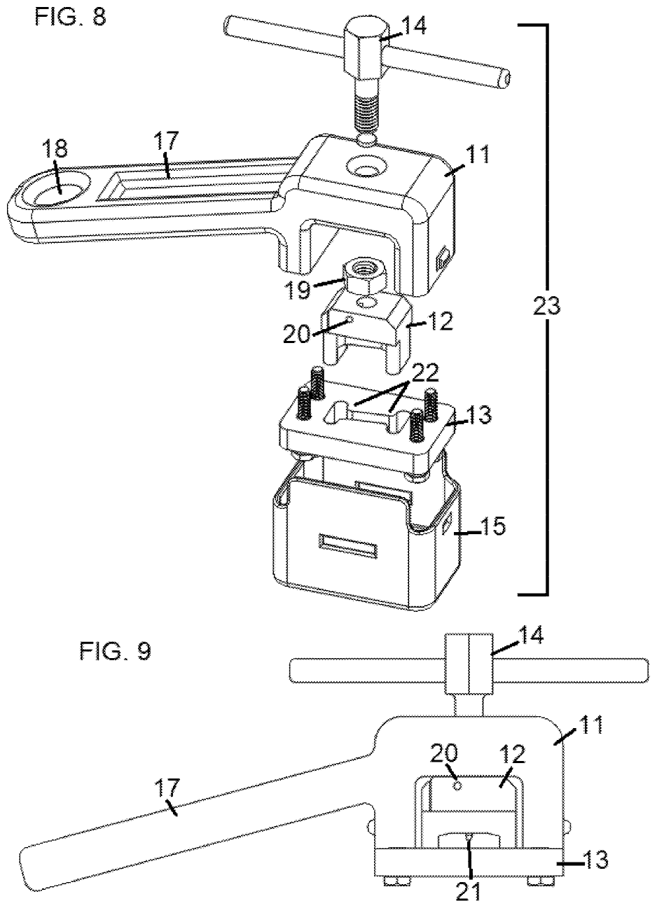

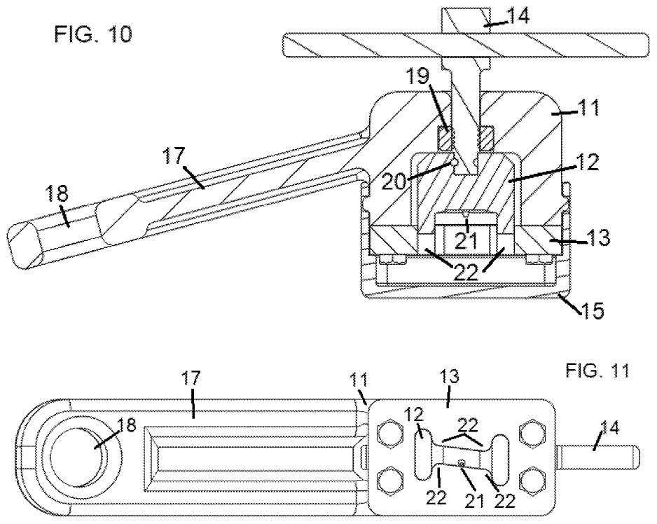

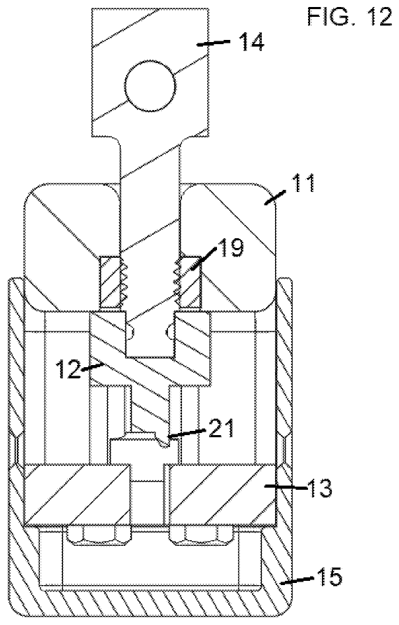

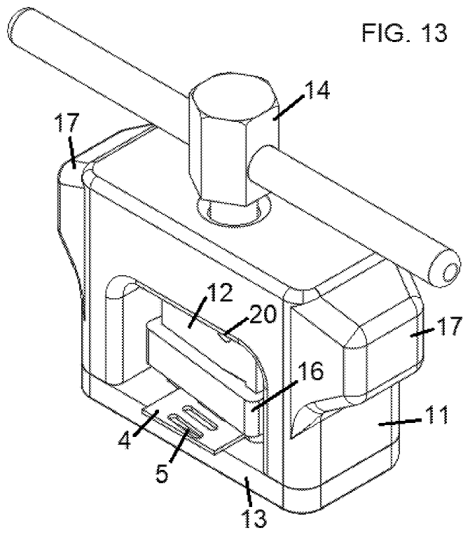

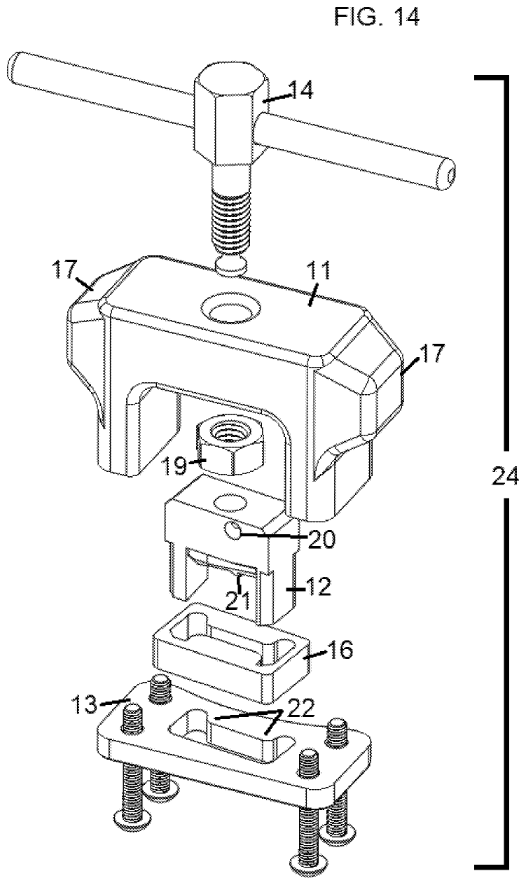

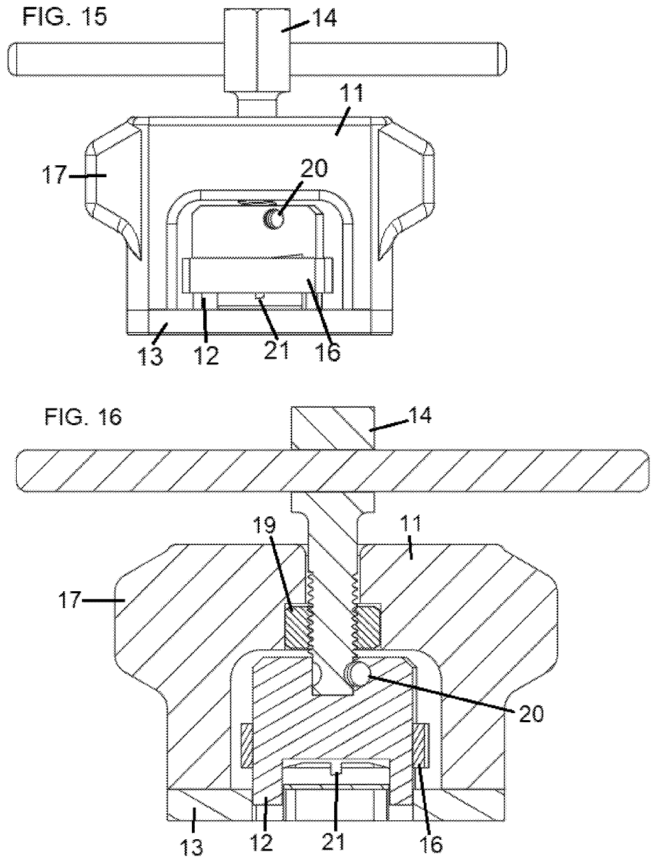

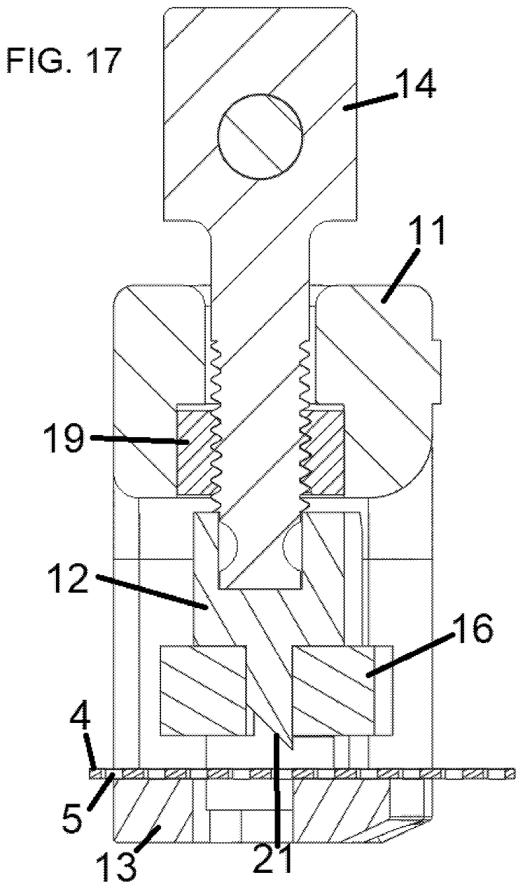

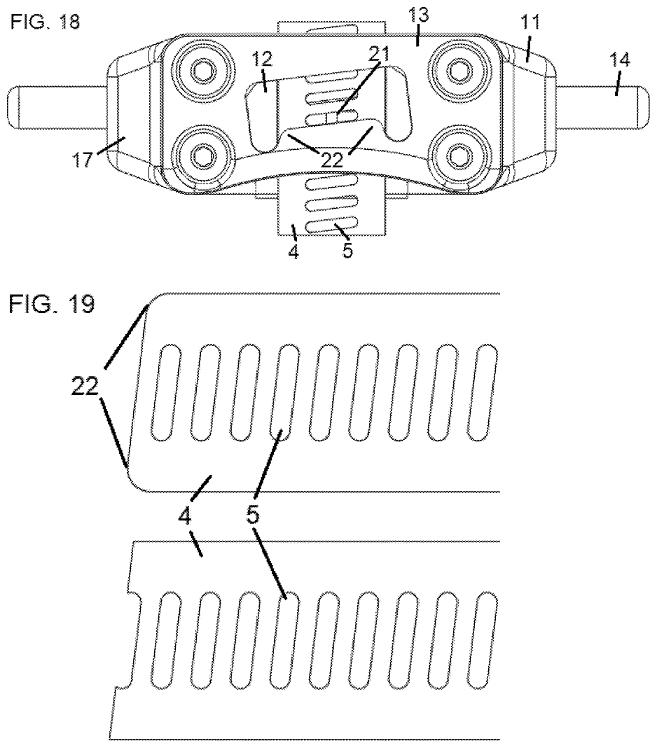

### DETAILED DESCRIPTION OF THE INVENTION

The present invention is a modular worm-drive clamp and band cutting system designed to allow users to create clamps of customized length and diameter. It is preferably made of metal, but can be made of plastic, composite, and the like. The system consists of two main components: a customizable hose clamp assembly (10) and a band cutting tool assembly (23, 24).

### Clamp Assembly (10)

The clamp assembly is constructed from multiple interlocking parts, including a housing frame (1), a spring clip with protrusions (2), a worm-drive screw (3), and a band (4).

### Housing Frame (1)

The housing frame serves as the primary structural element of the clamp. It houses and constrains the worm-drive screw (3) axially using a hole (8) or similar in the frame (1) and provides connection points for the spring clip (2). The housing may be formed as a single or multi-piece assembly. The housing may also have a protrusion that constrains the screw (3) laterally to prevent misalignment of the screw (3) and band (4) when under torque.

### Spring Clip (2)

A spring clip (2) is positioned within the housing frame (1) and functions as a releasable locking mechanism for the band (4). The spring clip (2) may be made of one or more pieces and has one or more protrusions configured to selectively engage the perforations (5) of the band (4). When the spring clip (2) is displaced by the user into an extended position, the protrusions are withdrawn from the perforations (5), allowing the band (4) to be freely inserted or adjusted within the housing frame (1). Upon release, the spring clip (2) returns toward a relaxed position, causing the protrusions to enter corresponding perforations (5) in the band (4), thereby locking the band (4) against linear movement. The spring clip (2) further resists lateral displacement of the band (4) while engaged.

### Worm-drive Screw (3)

The worm-drive screw (3) is supported axially within the housing frame (1) and interfaces with the perforations (5) of the band as it passes through the clamp. The screw (3) includes a user-drivable end (6), such as a slotted, hexagonal, or socket-type head, enabling tightening via common hand tools. The head may also have a “wing” feature with protrusions that allows for hand tightening. The tail end (7) of the screw is pivotably mounted (8), allowing the screw to swing upward and out of the way when the clamp is being opened or installed-a feature that enables rapid attachment and removal (quick-release function). A retention stop or nut (9) may be integrated at the tail end (7) of the screw (3) to prevent full disengagement from the housing (1) during pivoting.

### Band (4)

The band material is supplied in sections or as a continuous coil and features a series of evenly spaced perforations (5) sized to engage with both the protrusions of the spring clip and the worm-drive screw (4). The user cuts a suitable length of band (4) for the application and inserts it into the clamp assembly according to the installation procedure.

The term “perforation,” (5) as used herein, refers to spaced holes in the band (4) configured to interface with the threads of the screw (3); however, the design is not restricted to through-holes. Other features, such as indentations or deformations formed via molding, stamping, coining, or other suitable processes, may also be utilized to achieve engagement with the clamp assembly.

### Band Cutter Assembly (23, 24)

The band cutting tool is designed to provide clean, precise cuts of the banding material (4) with minimal risk of sharp edges or burrs on the finished clamp, enhancing both installation quality and user safety. The cutter assembly can be either for cutting the band at one (24) or two (23) locations. In embodiments utilizing two cutting locations, the cutter is particularly suited for use with continuous band stock, simultaneously separating a segment for immediate use while preparing an adjacent end for a subsequent clamp. In embodiments utilizing a single cutting location, the cutter is particularly well suited for trimming excess band material extending from an already installed clamp.

### Cutter Frame (11)

The frame of the cutter serves as the structural support for the cutting dies (12, 13) and threaded screw mechanism (14). It may include a handle (17) to facilitate the operator holding onto the tool. It can be equipped with a mounting point or hole (18) to allow attachment to a belt, carabiner, or workstation for easy transport or storage. The frame may also incorporate a threaded insert or integrated threads (19) for the cutting mechanism.

### Upper Cutting Die/Punch (12)

The upper die, or punch, is affixed to the threaded screw via a non-rotating connection (20), such as a pin, retaining ring, or swivel linkage, allowing vertical movement without rotational motion of the die (12). The die can include an alignment feature (21) (such as a projection) that ensures the band perforations (5) are properly aligned relative to the cutting blades (12, 13), providing consistent and accurate cuts. The punch is shaped to create rounded radii at the corners (22) of the cut band, eliminating sharp points. The punch can be shaped to cut the band at one or more locations.

### Lower Cutting Die/Anvil (13)

The lower die, or anvil, is part of or is fixed to the frame (11) and provides a complementary cutting surface to the upper die (12). Together, the dies act in a shearing motion when the screw and handle (14) is rotated, cutting through the band (4). The profile of the lower die matches the upper die to ensure smooth, burr-free cuts with controlled radii at the corners (22).

### Threaded Screw And Handle (14)

The upper die (12) is raised and lowered by a threaded screw mechanism connected to a T-handle or other manual actuation device. The handle can have a feature allowing the use of an additional tool, such as a hex head for use with a socket wrench. The threaded engagement allows the user to gradually apply high mechanical advantage to perform the cutting operation with minimal effort.

### Scrap Catcher (15)

An optional scrap catcher may be attached beneath the lower die (13) to capture the trimmed-off sections of the band (4). This catcher prevents scrap pieces from falling onto the ground or workspace, reducing the risk of sharp material causing injury or damage. The scrap catcher may be a removable tray, pocket, integral portion of the frame (11), or similar, and may be a part of either a double (23) or single (24) band cutter assembly.

### Band Holder (16)

A band holder may be incorporated into the cutter assembly to retain the band (4) during and after the cutting operation. The band holder may comprise a resilient or flexible material, such as an elastomeric member, positioned to apply a downward force onto the band as the upper die (12) is advanced toward the lower die (13). Upon completion of the cutting operation, the band holder maintains engagement with the severed portions of the band, thereby preventing the cut ends from unintentionally falling out of the cutter. This feature allows the user to safely and conveniently remove the cut band segments at their leisure.

### Assembly And Operation

In operation, the user selects a suitable length of perforated banding material based on the circumference of the item to be clamped. The user places the band through the band cutter, aligning it via a perforation guide feature if present, and rotates the handle to cut the band to the desired length. Once cut, the handle is then rotated the other way and the band is released.

One end of the cut band is then inserted into the clamp housing while the spring clip is raised to allow the band to travel under the spring protrusions. The spring clip is released and the protrusions pass through the perforations of the band and engage, preventing the band from pulling out of the housing. The band is then wrapped around the object to be clamped, and the free tail end is inserted through the opposite side of the housing where it engages with the worm-drive screw. The screw can be lifted and pivoted up out of the way of the incoming banding, allowing the band to quickly enter the housing. The screw can then be lowered and engage the banding. By turning the screw, the user can tighten the band to the desired tension. The lifting screw feature speeds up the installation of the clamp by reducing the number of turns of the screw required to fully tighten the clamp, as it is not necessary to have the screw spin through every band perforation.

For removal or adjustment, the worm-drive screw can be pivoted out of engagement, allowing the clamp to open quickly without full disassembly. If full disassembly is required, for example if an undersized length of banding is accidentally cut, the user can lift up on the spring clip such that the spring protrusions stop engaging with the band perforations and then remove the undersized band from the housing.

What is claimed is:

1. A clamp assembly comprising:
a band comprising a first end portion, a second end portion, and a plurality of engagement features spaced along the band, the engagement features comprising openings or surface deformations configured to be engaged by a worm-drive screw and by a spring clip;
a housing frame that receives and guides the first end portion and the second end portion of the band;
a spring clip supported by the housing frame, the spring clip comprising at least one spring-clip protrusion configured to engage at least one of the engagement features in the first end portion and thereby retain the first end portion in the housing frame; and
a worm-drive screw supported by the housing frame, the worm-drive screw comprising a threaded portion configured to engage the engagement features in the second end portion and, when rotated, advance the second end portion relative to the housing frame to tighten the band around an object,
wherein the worm-drive screw is pivotable relative to the housing frame between an engaged position in which the threaded portion engages the engagement features in the second end portion and a raised feed position in which the threaded portion is spaced from the band to permit the second end portion to be advanced through the housing frame without rotation of the worm-drive screw.

2. The clamp assembly of claim 1, wherein the openings comprise perforations extending through the band.

3. The clamp assembly of claim 1, wherein the surface deformations comprise indentations, stamped deformations, coined deformations, or molded deformations.

4. The clamp assembly of claim 1, wherein the spring clip is movable by a user from a relaxed locking position to an extended release position, the relaxed locking position positioning the at least one spring-clip protrusion in engagement with the first end portion, and the extended release position withdrawing the at least one spring-clip protrusion from the first end portion to permit insertion, adjustment, or removal of the first end portion.

5. The clamp assembly of claim 1, wherein the spring clip is configured to bias the first end portion toward the housing frame and to resist movement of the first end portion transverse to a direction of advancement of the first end portion through the housing frame while the at least one spring-clip protrusion is engaged with the first end portion.

6. The clamp assembly of claim 1, wherein a user-drivable end of the worm-drive screw comprises a slotted head, a hexagonal head, a socket-type head, or a winged hand-tightening head.

7. The clamp assembly of claim 1, wherein a tail end of the worm-drive screw comprises a retention stop or nut configured to prevent full disengagement of the worm-drive screw from the housing frame during pivoting of the worm-drive screw.

8. The clamp assembly of claim 1, wherein the housing frame comprises a hole or pivot opening that axially supports the worm-drive screw and a lateral screw-constraining protrusion configured to reduce misalignment between the threaded portion of the worm-drive screw and the band during tightening.

9. A band cutting tool comprising:
a frame having a band-receiving slot configured to receive a band having openings or surface deformations spaced along the band;
a lower cutting die fixed to or supported by the frame;
an upper cutting die aligned with the lower cutting die and movable toward the lower cutting die;
a threaded screw extending through a threaded portion of the frame and connected to the upper cutting die such that rotation of the threaded screw causes translation of the upper cutting die toward and away from the lower cutting die; and
a handle connected to the threaded screw and configured to rotate the threaded screw, wherein the upper cutting die and the lower cutting die have complementary cutting profiles configured to shear the band and form at least one cut end having rounded or radiused corner portions.

10. The band cutting tool of claim 9, wherein the upper cutting die comprises an alignment projection configured to engage one of the openings or surface deformations of the band to position the band relative to the upper cutting die and the lower cutting die before cutting.

11. The band cutting tool of claim 10, wherein the openings comprise perforations, and wherein the alignment projection is configured to enter one of the perforations of the band.

12. The band cutting tool of claim 9, wherein the threaded screw is connected to the upper cutting die by a non-rotating connection comprising a pin, a retaining ring, or a swivel linkage, the non-rotating connection permitting the upper cutting die to move axially in response to rotation of the threaded screw while restraining rotation of the upper cutting die.

13. The band cutting tool of claim 9, wherein the upper cutting die and the lower cutting die are configured to cut the band at two spaced cutting locations during a single advancement of the upper cutting die toward the lower cutting die.

14. The band cutting tool of claim 9, wherein the upper cutting die and the lower cutting die are configured to cut the band at a single cutting location.

15. The band cutting tool of claim 14, wherein the band-receiving slot and the single cutting location are arranged to receive excess band material extending from an installed clamp so that the upper cutting die and the lower cutting die can trim the excess band material without removing the installed clamp from an object.

16. The band cutting tool of claim 9, further comprising a scrap catcher positioned below the lower cutting die and configured to receive severed band material produced by the upper cutting die and the lower cutting die.

17. The band cutting tool of claim 9, further comprising a band holder comprising a resilient or flexible member positioned to apply downward force to the band during cutting and to retain severed portions of the band after cutting.

18. The band cutting tool of claim 9, wherein the handle comprises a T-handle extending laterally from the threaded screw, and wherein the handle or the threaded screw includes a hexagonal tool-engagement portion configured to be rotated by a socket wrench.

19. A method of forming and installing a clamp, the method comprising:
selecting a band having a first end portion, a second end portion, and a plurality of engagement features comprising openings or surface deformations;
placing the band in a band cutting tool having an upper cutting die and a lower cutting die;
rotating a threaded screw of the band cutting tool to move the upper cutting die toward the lower cutting die and cut the band, thereby forming a cut band having at least one cut end with rounded or radiused corner portions;
inserting the first end portion of the cut band into a housing frame of a clamp assembly;
engaging a spring clip supported by the housing frame with one or more of the engagement features in the first end portion to retain the first end portion in the housing frame;
wrapping the cut band around an object;
pivoting a worm-drive screw of the clamp assembly away from a band path in the housing frame;
feeding the second end portion of the cut band through the housing frame while the worm-drive screw is pivoted away from the band path;
moving the worm-drive screw into engagement with one or more of the engagement features in the second end portion; and
rotating the worm-drive screw to tighten the cut band around the object.

20. The method of claim 19, further comprising, after tightening the cut band, trimming excess material from the second end portion using a band cutting tool having upper and lower cutting dies that cut at a single cutting location while the cut band remains installed around the object.
